(19) United States
(12) Patent Application Publication
(10) Pub. No.: US 2018/0206683 A1
(43) Pub. Date: Jul. 26, 2018

(54) Disposable cardboard combination tissue dispenser and trash receptacle sun visor mounted self-adhesive hook and loop secured

(71) Applicant: Anita Elizabeth Brooke, Louisville, KY (US)

(72) Inventor: Anita Elizabeth Brooke, Louisville, KY (US)

(21) Appl. No.: 15/891,274

(22) Filed: Feb. 7, 2018

(51) Int. Cl. A47K 10/18; B60N 3/08; B60R 11/00

(52) U.S. Cl. CPC A47K 10/185; B60N 3/08; B60R 2011/0063; B60R 2011/0035; B60R 11/00

(57) ABSTRACT

A disposable, lightweight, half-cylinder shaped, lengthwise cut, cardboard box, dispensing fifteen tissues at one end, and an internal cardboard divider allowing a hollow end for tissue disposal. Pre-stuck hook and loop strips on the flat back of the box adhere to the sun visor of a vehicle. When the clean tissues are all gone, the whole invention is tugged off the visor and disposed of.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

I endeavored to create a disposable, lightweight, half-cylinder, lengthwise shaped cardboard box that would dispense fifteen disposable tissues and also function as a trash receptacle for the tissues for use on the sun visor in a vehicle. I use two hook and loop strips with self-adhesive backing that is pre-stuck on the invention which adheres to the sun visor in a vehicle. This invention would be stuck to the visor until all tissues were used-up and discarded in the hollow half. Then, the entire box is intended to be pulled off the visor and disposed of. My invention is disposable whereas all the other inventions use brackets, clips, or elastic. Their drawbacks are complexity of design because the attachments are not easily integrated with a tissue dispenser manufacturer. A tissue manufacturer could incorporate the hook and loop strips with a sticky back onto this tissue box and sell it as one item. This invention with the hook and loop strips using a sticky back to support a tissue box on a sun visor would be inexpensive to manufacture, safe, aesthetically pleasing, easy to adhere, easy to use, and easy to remove. The disposable aspect would appeal to tissue manufacturers because buyers must keep replacing the entire product for their visor.

Previous inventions include but are not limited to the following:

A visor-attached tissue pack with trash receptacle is mounted slidably in a sleeve-like fashion as disclosed in U.S. Pat. No. 3,026,999 A (Constantino). A tissue dispenser attached to the sun visor using clips is disclosed in U.S. Pat. No. 2,278,011 (Murdock).

Another visor-attached tissue holder uses elastic to hold it in place and is meant only to be refilled without removing the tissue box as disclosed in U.S. Pat. No. 5,332,138 (Gross).

### BRIEF SUMMARY OF THE INVENTION

This invention provides a convenient way to use and dispose of tissues in the vehicle. Previously, inventions used brackets, clips, or elastic to attach tissues to a visor. My invention is completely made of disposable pieces, mostly cardboard and paper. Hook and loop strips with sticky backing allow user to mount and remove the tissue box easily. It is a half-cylinder cut lengthwise so that a flat back side may be glued to it. The flat back side adheres then to the visor with the assistance of hook and loop strips.

### BRIEF DESCRIPTION OF THE SEVERAL VIEWS OF THE DRAWING

FIG. 1 is a view from above and reveals the top curved side of the invention.
#1 is a view of the tissue
#2 is a view of the curved half-cylinder cardboard box
#3 is a view of the hidden divider piece that separates the tissue dispenser from the trash receptacle
#4 is a view of the end piece
#5 is a view of the plastic film attached to the end piece that allows easy access to either the tissues or the trash receptacle

FIG. 2 is a view of the back of the invention and reveals a flat, rectangular piece with one hook and loop strip that will attach itself to another hook and loop strip that will adhere to the sun visor.

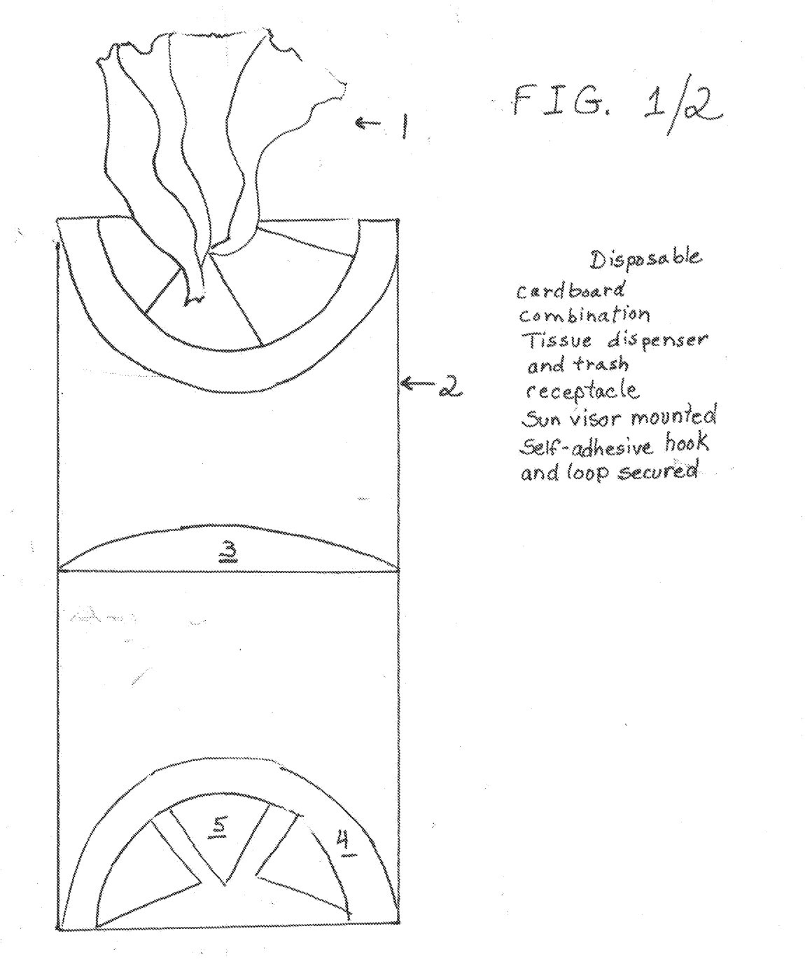

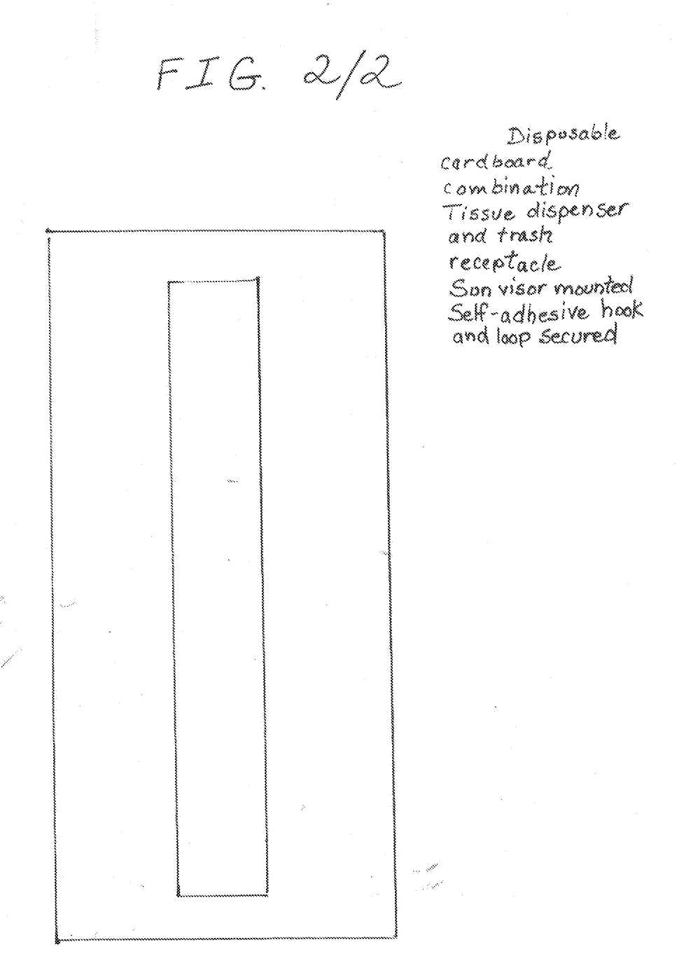

### DETAILED DESCRIPTION OF THE INVENTION

A seventeen centimeter (17 cm) long, curved, half-cylinder tube, with diameter eight centimeters (8 cm), is cut lengthwise and filled with fifteen (15) tissues using half the volume. The tissues dispense at one end. The other half of the cylinder is hollow to allow the space to be used as a trash receptacle for used tissues. The end piece is a semi-circular one millimeter thick (1 mm) paper coated with a plastic film for easy removal of tissues. End piece on other end allows for easy disposal of tissues. The back side is a flat, rectangular piece of cardboard seventeen centimeters (17 cm) length and eight centimeters (8 cm) width which is taped to the half-cylinder. Two (2) hook and loop strips with a sticky back are attached to the invention so that, when purchased, the ability to attach invention to the sun visor is obtainable by pulling back the white protective strip to reveal the sticky portion of the strip and adhering the invention to the sun visor. This invention is snugly secured until product is all used up. Simply tug on the tissue box and will easily disconnect from the visor with no messy residue. Lastly, discard the whole invention into the recycling bin or appropriate trash can. Other inventions use brackets, clips, or elastic. They are not disposable. Their drawbacks are complexity of design because the support for the tissue box is a separate item from the tissue box itself. This invention solves that problem by pre-attaching hook and loop strips onto the tissue box and selling it as one item. This invention with hook and loop strips using a sticky back to support a tissue box on a sun visor would be inexpensive to manufacture, safe, aesthethically pleasing, easy to adhere, easy to use, easy to remove, and easy to dispose of. The disposable aspect would appeal to manufacturers because buyers must keep replacing the entire product for their visor.

1. A disposable cardboard tissue box to be temporarily attached to the sun visor of a vehicle via hook and loop strips, which are attached to the bottom panel, said box containing a plurality of tissues, having a generally half-cylinder, lengthwise cut to be the top panel.

2. The device of claim 1 wherein the opening at each end is a semi-circle in shape.

3. The device of claim 1 wherein the bottom panel is rectangular in shape.

4. The device of claim 1 wherein the trash and receptacle compartments are separated internally by a cardboard, semi-circle disc, which is glued in place at the halfway point.

5. The device of claim 1 wherein the invention has pre-adhered two hook and loop strips with a sticky adhesive backing.
